(19) United States
(12) Patent Application Publication
(10) Pub. No.: US 2007/0060348 A1
(43) Pub. Date: Mar. 15, 2007

(54) SYSTEM FOR PRESENTING GAMING RESULTS EMPLOYING A GAMING DISPLAY INTERACTIVE CHARACTER

(76) Inventor: Galen Tanner Svanas, Austin, TX (US)

Correspondence Address: THE CULBERTSON GROUP, P.C., 1114 LOST CREEK BLVD., SUITE 420, AUSTIN, TX, 78746, US

(21) Appl. No.: 11/531,636

(22) Filed: Sep. 13, 2006

Related U.S. Application Data
(60) Provisional application No. 60/716,795, filed on Sep. 13, 2005.

(51) Int. Cl. A63F 13/00

(52) U.S. Cl. 463/31

(57) ABSTRACT

A method includes displaying a gaming graphic at a player station. This gaming graphic includes a result conveying component and a background component with the background component located in a peripheral area surrounding at least a portion of the result conveying component. The method also includes periodically changing the background component from a first configuration to a different configuration during the course of play at the player station. However, the appearance of the result conveying component is maintained while the background component is periodically changed. The background component may include a game character that is animated in a character interaction sequence after a character activating configuration is displayed for the result conveying component.

### CROSS-REFERENCE TO RELATED APPLICATION

The Applicants claim the benefit, under 35 U.S.C. §119(e), of U.S. Provisional Patent Application No. 60/716,795 filed Sep. 13, 2005, and entitled “SYSTEM FOR PRESENTING GAMING RESULTS EMPLOYING A GAMING DISPLAY INTERACTIVE CHARACTER.” The entire content of this provisional application is incorporated herein by this reference.

### TECHNICAL FIELD OF THE INVENTION

This invention relates to gaming machines and systems. More particularly, the invention relates to methods for presenting gaming results to a player through a video generated game presentation that employs a character which interacts with a result conveying portion of the game presentation display.

### BACKGROUND OF THE INVENTION

A large number of different gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Video-based gaming machines may also be used to show card games or various types of competitions such as simulated horse races in which wagers may be placed. Game manufacturers are continuously pressed to develop new game presentations, formats, and game graphics in an attempt to provide high entertainment value for players and thereby attract and keep players.

### SUMMARY OF THE INVENTION

The present invention includes a highly entertaining method of presenting gaming results. The entertainment value is achieved by using a video generated display to present certain unique types of graphic presentations to the player in the course of play. The present invention also encompasses both a gaming apparatus and program products for implementing methods according to the invention.

A method embodying principles of the invention may be implemented using one or more display devices such as CRTs, LCDs, plasma displays, or other types of display devices. The display device or devices used to show graphic elements according to the invention will commonly be associated with a gaming machine through which a player may participate in a game. As used in this disclosure and the accompanying claims, a gaming machine through which the present invention may be implemented will be referred to generally as a player station.

One preferred method according to the invention includes displaying a gaming graphic at a player station. This gaming graphic includes a result conveying component and a background component with the background component located in a peripheral area surrounding at least a portion of the result conveying component. The method also includes periodically changing the background component from a first configuration to a different configuration during the course of play at the player station. However, the appearance of the result conveying component is maintained while the background component is periodically changed.

Another preferred method according to the invention includes similarly displaying a gaming graphic at a player station, with the gaming graphic having a result conveying component and a background component. However, this form of the invention also includes a game character displayed with the background component. This form of the invention also includes displaying the result conveying component in a character activating configuration during the course of game play. After displaying the result conveying component in the character activating configuration, a character interaction sequence is displayed which includes a visible interaction between the gaming character and one or more graphic symbols included in the result conveying component.

An apparatus embodying the principles of the present invention includes a player station having a display device, a player input device, and a presentation controller. The presentation controller performs several functions according to the invention. In one form of the invention the presentation controller causes the display device to display the gaming graphic described above having a result conveying component and a background component with the background component located in a peripheral area surrounding at least a portion of the result conveying component. The presentation controller also periodically causes the background component to change from a first configuration to a different configuration during the course of play at the player station. The presentation controller, however, maintains the result conveying component in a first configuration while the background component is periodically changed.

In another form of the invention the presentation controller causes the display device to display the version of the game graphic which also includes the game character. In this form of the invention the presentation controller also periodically causes the display device to display the result conveying component in the character activating configuration in response to a result for the game play, and then goes on to cause the display device to display the character interaction sequence as described above.

The result presented to a player as an award according to the invention may be obtained in any suitable fashion. In some forms of the invention, the apparatus may receive results identified from a separate device or system. Particularly in these forms of the invention, the result may actually be a result from an electronic lottery game, a bingo game, or some other game. In other forms of the invention, a result controller may be included at the player station and adapted to communicate a game play result to the presentation controller in response to a result requesting input entered through the input device. Whether the result is obtained from a separate device or from some component at the player station itself, the presentation controller controls the symbols displayed in the course of a game cycle to be consistent with the given result. The result produced by the local result controller or received from a remote result controller for a given play in the game preferably dictates both the result displayed in the base game presentation and the result displayed in any bonus game presentation provided at the player station. Regardless of any underlying game from which a result is identified in the present invention, a “play” or “game play” referenced in this disclosure will refer to the game cycle of a graphic presentation according to the invention, that is, a cycle through the game from a wager to showing the result for that wager.

These and other advantages and features of the invention will be apparent from the following description of preferred embodiments, considered along with the accompanying drawings.

### BRIEF DESCRIPTION OF THE DRAWINGS

FIG. 1 is a perspective view of a player station that may be used to implement a game presentation according to the invention.

FIG. 2 is a diagrammatic representation of a player station and gaming system that may be used to implement methods according to the present invention.

FIG. 3 is a representation of a graphic display that may be generated to display a gaming result according to the present invention.

FIG. 4 is a representation of a graphic display similar to that shown in FIG. 3, but showing a different background component with the same result conveying component shown in FIG. 4.

FIG. 5 is a representation of a graphic display similar to that shown in FIGS. 3 and 4, but showing a different background component with the same result conveying component shown in FIGS. 3 and 4.

FIG. 6 is a representation of a paytable that may be used to correlate arrangements of reel symbols with various prizes in the result displaying component shown in FIGS. 4-6.

FIG. 7 is a representation of an additional paytable that may be used to correlate arrangements of reel symbols with various prizes in the result displaying component shown in FIGS. 3-5.

FIG. 8 is a flowchart illustrating processes for displaying gaming results in accordance with the present invention.

FIGS. 9A-E show a sequence of graphics displayed in accordance with a transition to a second screen bonus feature according to one form of the invention.

FIGS. 10A-L show a sequence of graphics displayed in accordance with a second screen bonus according to one form of the invention.

FIG. 11 shows a view position diagram for the sequences shown in FIGS. 9A-E and 10A-L.

### DESCRIPTION OF ILLUSTRATIVE EMBODIMENTS

The claims at the end of this document set out novel features which the Applicant believes are characteristic of the invention. The various advantages and features of the invention together with preferred modes of use of the invention will best be understood by reference to the following description of illustrative embodiments read in conjunction with the drawings introduced above.

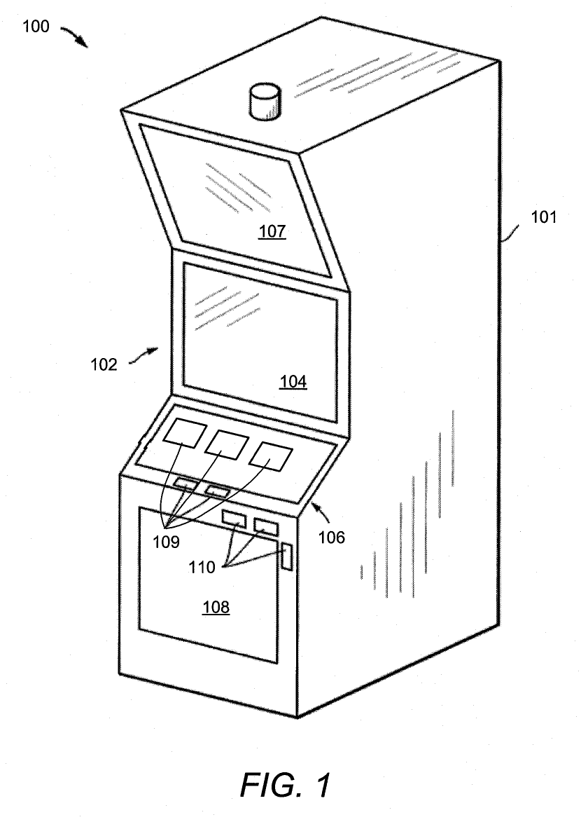

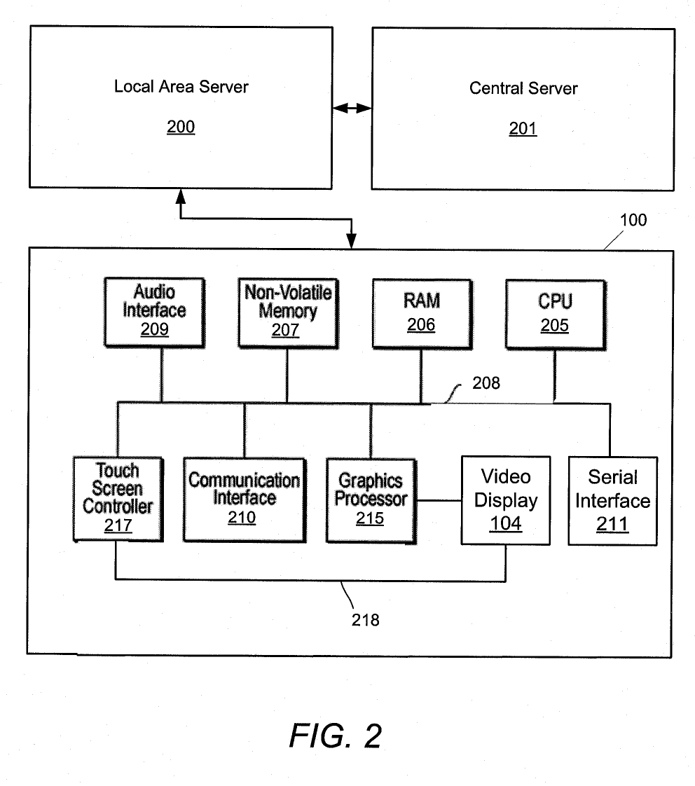

FIG. 1 shows a player station 100 that may be used to implement game presentations according to the present invention. The block diagram of FIG. 2 shows further details of player station 100 connected in a gaming system in which the present invention may be used to present gaming results to players.

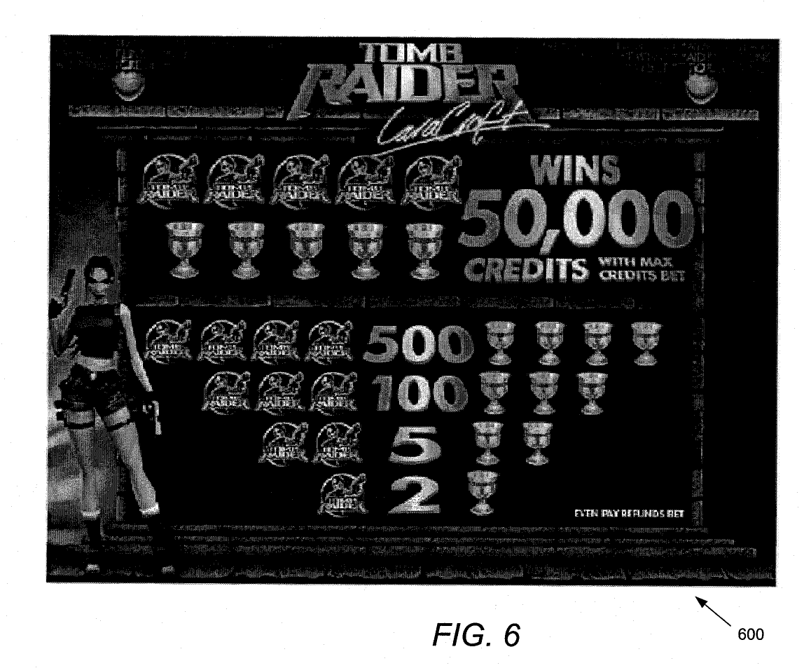

Referring to FIG. 1, player station 100 includes a cabinet 101 having a front side generally shown at reference numeral 102. A video display device 104 is mounted in a central portion of the front surface 102, with a ledge 106 positioned below the video display device and projecting forwardly from the plane of the video display device. In addition to the video display device 104, the illustrated player station includes a top glass display 107 positioned above the video display device, and a belly glass display 108 positioned below the video display device. In the illustrated player station 100, video display device 104 is used to produce the graphic components making up the game presentation according to the invention. That is, video display device 104 displays the symbol locations and graphic symbols contained in those locations, displays the change processes shown at the symbol locations, and also displays the symbols that correlate to the player's result for a game play. In player station 100, top glass display 107 and bottom glass display 108 contain static graphics related to the particular game presentation. For example, top glass display 107 may show a paytable such as the paytable described below in connection with FIG. 5. Bottom glass display 108 may show additional graphics related to the graphics shown at top glass display 107 and video display device 104.

Player station 100 illustrated in FIG. 1, includes mechanical player control buttons or other input devices 109 mounted on ledge 106. Other forms of the invention may include switches, joysticks, or other player input devices mounted on ledge 106.

It will be appreciated that player stations may also include player interface devices in addition to devices that are considered player controls for use in playing a particular game. Player station 100 also includes additional player interface devices 110 on a lower portion of cabinet 101 generally in the plane of bottom glass display 108. These additional player interface devices 110 may comprise for example, a player card reader, a voucher or ticket reader/issuer, a currency acceptor/validator, and/or a coin or token acceptor/dispenser.

It should be noted that the present invention is by no means limited to implementation with a player station having a single video display such as player station 100 shown in FIG. 1. A game presentation made according to some forms of the present invention may be produced with any player station that includes a player interface for enabling a player to make direct inputs, and one or more video display devices, or physical reel arrangements through which the various graphic elements of the game presentation may be produced. Player station 100 is merely shown as an example of a player station through which the invention may be implemented. Other player stations implementing the present invention may include other types of devices that may show game play results. For example, a player station may include a spinning wheel to show results. These other types of result display devices may be used to show some gaming results to the player, while the presentation according to the invention may be used to show other results. It should also be noted that the video display device 104 used in player station 100, or some other player station that may be used to implement the invention, may comprise any suitable video display device including a cathode ray tube, liquid crystal display, plasma display, LED display or any other type of video display currently known or that may be developed in the future.

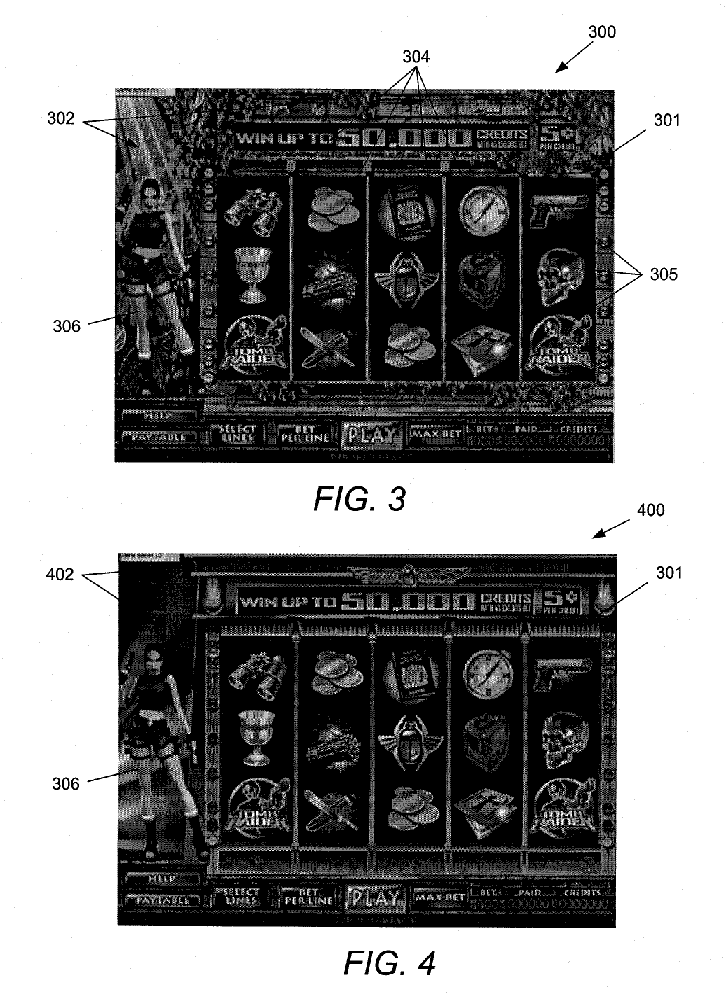

FIG. 2 provides a block diagram showing various components of player station 100 together with gaming system components external to the player station. In particular, FIG. 2 shows player station 100 connected for communication with a local area server 200 and a central server 201. Local area server 200 and central server 201 may be used together with player station 100 and other player stations to implement a bingo gaming system, such as the bingo gaming system described in U.S. patent application publication No. 2004-0152499-A1, or to implement a lottery gaming system such as the lottery gaming system shown in U.S. patent application publication No. 2005-0137010-A1 or U.S. Pat. No. 6,733,385, for example. Regardless of the precise manner in which results are identified in a given system, local area server 200 and central server 201, or both servers, may cooperate to identify results that are provided to player station 100 in response to a result requesting input entered at the player station. That is, local area server 200 and/or central server 201, or more particularly, one or more processing devices associated with server 200 and/or server 201 may serve as a result controller for identifying results used by player station 100 as described further below with reference to FIG. 3. Even in implementations in which results are produced at the player station 100 in some fashion, local area server 200 and/or central server 201 may be used to provide player tracking and accounting services for the player stations included in the gaming system.

FIG. 2 shows that player station 100 includes a central processing unit (CPU) 205 along with random access memory 206 and nonvolatile memory or storage device 207. All of these devices are connected on a system bus 208 with an audio interface device 209, communications interface 210, and a serial interface 211. A graphics processor 215 is also connected on bus 208 and is connected to drive the video display device 104 (mounted on cabinet 101 as shown in FIG. 1). As shown in FIG. 2, player station 100 also includes a touch screen controller 217 connected to system bus 208. Touch screen controller 217 is also connected via signal path 218 to receive signals from a touch screen element associated with video display device 104. It will be appreciated that the touch screen element itself comprises a thin film that is secured over the display surface of video display device 104. The touch screen element itself is not illustrated or referenced separately in the figures.

Those familiar with data processing devices and systems will appreciate that other basic components will be included in player station 100 such as a power supply, cooling systems for the various system components, audio amplifiers and speakers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217. Thus, the touch screen controller may not be connected to the system bus 208, but instead include a serial communications line to serial interface 211, which may be a USB controller or a IEEE 1394 controller for example. It will also be appreciated that some of the devices shown in FIG. 2 as being connected directly to system bus 208 may in fact communicate with the other system components through a suitable expansion bus. Audio interface 209, for example, may be connected to the system via a PCI bus. Numerous other variations in the player station internal structure and system may be used without departing from the principles of the present invention.

It will also be appreciated that graphics processors are also commonly a part of modem computer systems. Although separate graphics processor 215 is shown for controlling video display device 104, it will be appreciated that CPU 205 may control the video display device directly without any intermediate graphics processor. The invention is not limited to any particular arrangement of processing devices for controlling the video display device.

In the illustrated player station 100, CPU 205 executes software which ultimately controls the entire player station including the receipt of player inputs and the presentation of the graphic symbols at the various symbol locations displayed according to the invention through the video display device 104 associated with the player station. Thus, CPU 205 either alone or in combination with graphics processor 215 serves as a presentation controller according to the invention. Where the player station itself produces results for a player, CPU 205 also serves as a result controller. CPU 205 also executes software related to communications handled through communications interface 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of player station operation. Communications interface 210 provides an interface to other components of a gaming system that may be involved in game play, such as local area server 200 and/or central server 201.

It should be noted that the invention is not limited to player stations employing the personal computer-type arrangement of processing devices and interfaces shown in example player station 100. Other player stations may include one or more special purpose processing devices to perform the various processing steps for implementing the present invention. Unlike general purpose processing devices such as CPU 205, these special purpose processing devices may not employ operational program code to direct the various processing steps.

The following description describes the operation of a base game presentation and several bonus game presentations that may be displayed at a player station such as player station 100 in accordance with forms of the present invention. In addition to the displays described below and shown in the figures, a process according to the present invention may also receive or produce a result for the game cycle at a suitable point of the game presentation process. For example, the player input to initiate a play in the game may prompt the player station to request a result from a result controller at the player station or elsewhere in the gaming system (such as components 200 or 201 in FIG. 2). The result controller then communicates back a result for the game cycle. The result or data included in or correlating to the result may then be used at the player station to control the display produced at the player station. In particular, the player station ultimately displays an arrangement of symbols consistent with the result that has been assigned for the game cycle. It will be appreciated, however, that a result may be received at a number of appropriate points in the game presentation. For example, a result may be acquired each time the initial display is produced, before a player has even entered a game play input at the player station. Alternatively, a result for a play in the game may be obtained while the process is conducting the symbol change processes (spin the reels in the result conveying component of the game graphic). It should also be noted that the invention is not limited to applications where a result is obtained and the graphics are forced to correspond to that result. Rather, the reel spinning process (simulated reel spinning process) may be the processes that dictate the result for the game cycle. That is, the process may use some random or pseudo-random process to select the reel symbols ultimately displayed at the various symbol locations to dictate the result for the play in the game.

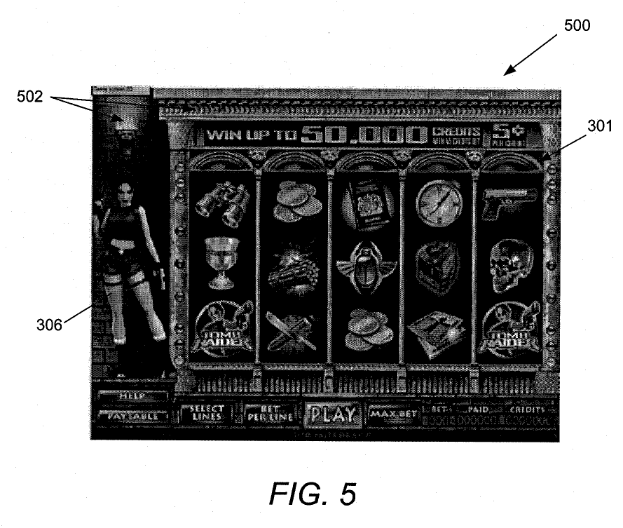

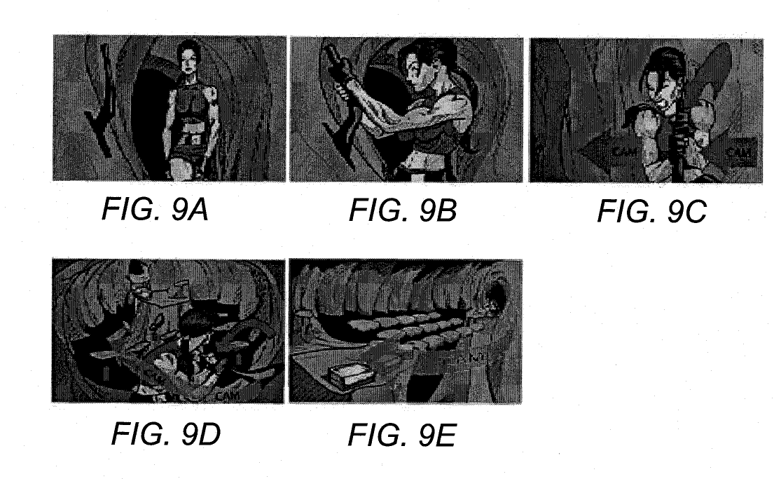

One aspect of the present invention may be described with reference to the example game screen shots shown in FIGS. 3, 4, and 5. Referring first to FIG. 3, a gaming graphic 300 includes an overall graphic display which may be displayed at a player station such as player station 100 shown in FIGS. 1 and 2 using the player station video display 104 for example. Gaming graphic 300 includes a result conveying component 301 and a background component shown generally at reference numeral 302. Background component 302 is generally located in a peripheral area along at least one side of result conveying component 301. The illustrated result conveying component 301 is made up of five simulated spinnable reels 304, each sized and configured to show a column of three reel symbols 305. The example background area 302 shown in FIG. 3 also includes a game character 306 which will be described further below in connection with FIGS. 8-10. The graphic making up background area 302 in FIG. 3 also includes graphics which generally represent a theme for the gaming graphic. The particular theme presented by the graphics of background component 302 in FIG. 3 includes a jungle theme showing lush vegetation. FIG. 4 shows a gaming graphic 400 similar to that shown in FIG. 3 including substantially the same result conveying component 301. However, the background component 402 shown in FIG. 4 presents a different graphical theme. In particular, the theme for the background component graphics shown in FIG. 4 may be referred to as an Egyptian or desert theme. FIG. 5 also shows a gaming graphic 500 similar to gaming graphic 300 shown in FIG. 3, including substantially the same result conveying component 301. The background component 502 shown in FIG. 5, however, presents a different theme from either background component 302 shown in FIG. 3 or background component 402 shown in FIG. 4. The theme presented by background component 502 in FIG. 5 may be referred to as a gothic theme.

According to one aspect of the invention, a player station such as player station 100 presents a gaming graphic such as graphic 300 shown in FIG. 3 with result conveying component 301 and background component 302 located in a peripheral role area surrounding at least a portion of the result conveying component. This gaming graphic is periodically changed to show a different background component such as background component 402 shown in FIG. 4 or background component 502 shown in FIG. 5. However, even though the background component is changed from one configuration to another, the result conveying component 301 remains substantially unchanged. A change from any of the gaming graphics 300, 400, and 500 shown in FIGS. 3, 4 and 5, respectively to any one of the other gaming graphics is an example of a background component change according to the present invention.

This process of periodically changing the gaming graphic at a player station to change a background component (302 in FIG. 3, 402 in FIG. 4, and 502 in FIG. 5) while maintaining a substantially common result conveying component 301 has the effect of keeping the gaming graphic fresh for the player while minimizing the effect on the play of the game. For example, in all of the gaming graphics shown in FIGS. 3-5, the pay tables, reel symbols, game rules, and underlying probabilities associated with potential results in the game all remained constant between the different gaming graphics. However, the change from one background component (302, 402, and 502) to another has a significant effect on the appearance of the game and may help hold the player's interest.

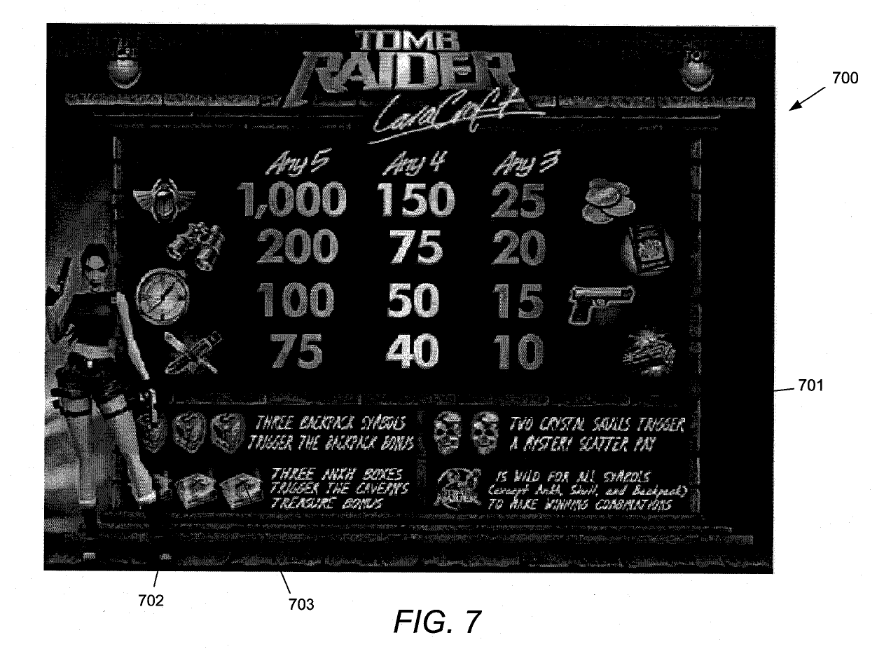

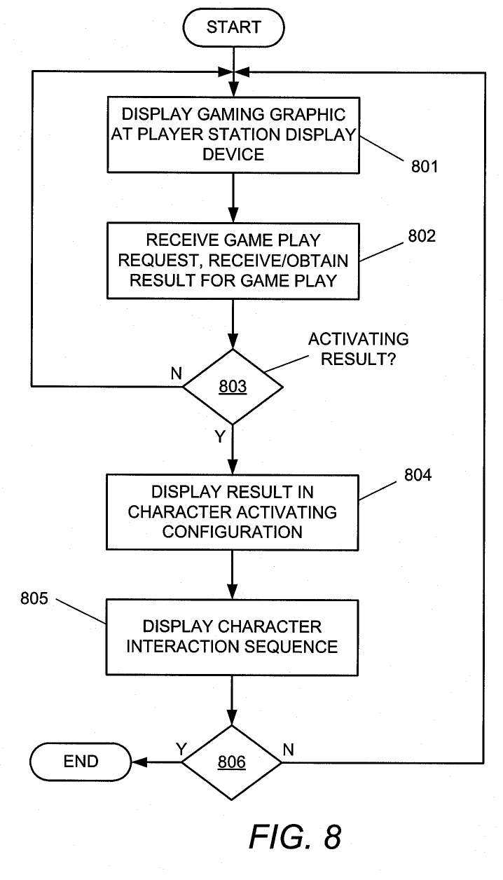

In one preferred form of the invention, the player station CPU, such as CPU 205 shown in FIG. 2 executes presentation control program code to implement a presentation controller for causing the player station display device (such as display 104 in FIGS. 1 and 2) to display the gaming graphic having the result conveying component 301 in FIGS. 3-5 and background component 302, 402, and 502. The presentation controller also periodically changes the background component 302, 402, or 502 while maintaining the result conveying component 301 in substantially the same form. Substantially the same form in this sense includes retaining a common simulated reel configuration of five reels for example, having the same paylines, and using the same paytables. For example, the gaming graphics 300, 400, and 500 may each employ the two paytables 600 and 700 shown in FIGS. 6 and 7, respectively. The presentation controller (e.g. CPU 205 in FIG. 2) may select a different background component from two or more stored alternate background components. The alternate background components may be stored in random access memory or nonvolatile memory associated with the presentation controller such as CPU 205 in FIG. 2, or in memory of associated with a graphics processor such as graphics processor 215 shown in FIG. 2. The periodic change in the background component may be performed by the presentation controller according to a fixed schedule, randomly according to some background changing algorithm, or based on a number of plays made at the player station with a given background component. Also, some forms of the invention allow any one of the alternate background components to be selected manually by the player using a suitable player control at the player station. For example, where the player station includes a touchscreen over the entire surface of the display device used to produce the gaming graphic, the presentation controller may be configured to change the background component for the gaming graphic in response to a touch detected anywhere in the area of the display defining the background component. Alternatively, the presentation controller may change the background component for the gaming graphic in response to a signal initiated by a mechanical or virtual (touch screen) button at the player station.

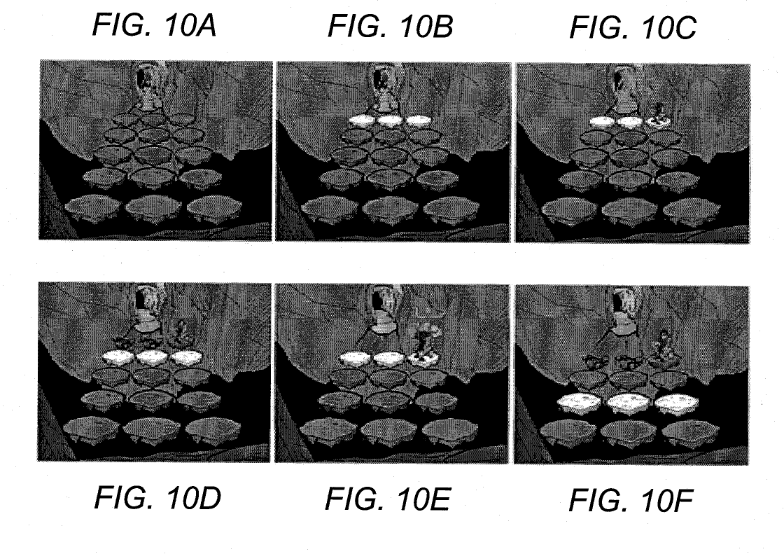

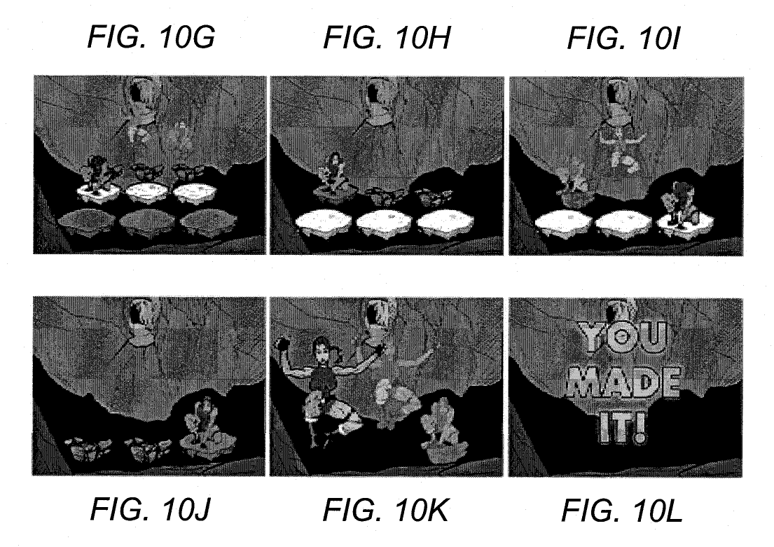

Another aspect of the invention may be described with reference to the flow chart of FIG. 8 and to the example game graphics shown in FIG. 3, example paytable shown in FIG. 7, and example bonus game graphics shown in FIGS. 9A-E and FIGS. 10A-L. Referring first to the flow chart of FIG. 8, this aspect of the present invention includes displaying a gaming graphic having a result conveying component and a background component as indicated at process block 801 in FIG. 8. The result conveying component and background component may comprise result conveying component 301 and background component 302 shown in FIG. 3 for example, although the invention is not limited to any particular set of graphics. Regardless of the specific graphics displayed, the background component includes a game character such as game character 306 in FIG. 3. This game character 306 animates according to the invention to serve as a partner or supporter for the player in the course of game play. In particular, the game character may cooperate with the player to conduct first and second screen that bonuses.

As shown in FIG. 8, the player station (such as player station 100 in FIGS. 1 and 2) receives a game play input entered in some suitable fashion by a player at the player station, and produces or receives a result for the game play input as indicated at process block 802 in FIG. 8, and determines if the result is a character activating result. If the result is not a character activating result, as indicated by a negative result at decision block 803, the process simply displays the gaming graphic as indicated at process block 801. This graphic may or may not indicate a prize according to the applicable prize tables such as prize tables 600 and 700 in FIGS. 6 and 7, respectively. However, if the result received or produced at process block 802 is determined to be a character activating result as indicated by a positive result at decision block 803, the process proceeds to display the result conveying component of the gaming graphic (such as 301 in FIG. 3) in a character activating configuration. This display of the result conveying component in a character activating configuration is shown at process block 804 in FIG. 8. This character activating configuration preferably corresponds to a result definition in an applicable paytable such as paytable 600 in FIG. 6 and paytable 700 in FIG. 7. The process then includes displaying a character activation sequence on the display device (such as display 104 in FIGS. 1 and 2) as indicated at process block 805 in FIG. 8. The process then loops back to a position to receive another game play request from the player, or terminates if the layer station is shut down as indicated by the alternatives from decision block 806.

Character activating configurations displayed according to process block 804 may be described with reference to paytable 700 shown in FIG. 7. This example paytable 700 shows three different potential character activating configurations. One character activating configuration is shown generally at reference numeral 701 and is described in the text as a “Mystery Scatter Pay” which is triggered by two or more crystal skull reel symbols appearing in the result conveying component of the gaming graphic. Another character activating configuration described in FIG. 7 is defined as three backpack reel symbols to trigger a “Backpack” bonus game as shown generally at reference numeral 702. The third character activating configuration described in FIG. 7 is shown at reference numeral 703 and includes the three ankh box reel symbols which triggers a “Caverns Treasure” bonus game. If the result conveying component is displayed in any of these character activating configurations defined in paytable 700 when the simulated reels shown in FIG. 3 stop spinning for a given play in the game, the process proceeds to a character interaction sequence as indicated at process block 805 in FIG. 8. This character interaction sequence includes a visible interaction between the game character such as game character 306 in FIG. 3 for example and one or more reel symbols such as reel symbols 305 in FIG. 3 shown in result conveying component 301.

In the case of the character activating configuration defined as the Mystery Scatter Pay bonus, two or more crystal skull reel symbols will be displayed in result conveying component 301 in FIG. 3 when the simulated reels 304 stop spinning. Once this particular character activating configuration is displayed, game character 306 is animated to target and fire a weapon at the crystal skull reel symbols. The reel symbols then break apart to reveal a result for the play.

In the case of the example character activation configuration defined as the Backpack bonus, simulated reels 304 will have stopped spinning for a given play in the game showing three or more backpack reel symbols in result conveying component 301. The player is then prompted in some fashion to select one of the backpack reel symbols. This prompt may be by a voice (audio) appearing to emanate from game character 306, for example, or by some other display or notice at the player station. Where result conveying component 301 of gaming graphic 300 is shown on a touchscreen display device, the player may make their selection by touching a particular one of the crystal skull reel symbols. However, the invention is not limited to any particular technique for enabling the player to select one of the reel symbols. Once the player selects one of the backpack reel symbols, game character 306 is animated to traverse result conveying component 301 to reach the selected reel symbol. Game character 306 may then be displayed in result conveying component 301 picking up the selected backpack reel symbol to remove it from its original location in the result conveying component, and then open the backpack to reveal a result for the play. The result revealing process may, for example, show game character 306 removing an object from the backpack and this object may ultimately display the result to the player. After revealing the result the graphic may be controlled to cause the backpack and object to disappear, and game character 306 may be controlled to congratulate the player and cross the screen to return to the “idle position” in background component 302 of the gaming graphic 300.

Both of the previous examples of a character interaction sequence according to the invention relate to first screen bonus games in which the gaming graphic does not change other than as necessary to animate game character 306 and to display the interaction with the reel symbol. In other forms of the invention, the character interaction sequence may involve a second screen bonus, that is, a display that substantially replaces the entire original gaming graphic such as gaming graphic 300 shown in FIG. 3. FIGS. 3, 9A-E, and 10A-L may be used to describe one second screen bonus employing a character interaction sequence embodying the principles of the present invention. Starting with the gaming graphic 300 shown for example in FIG. 3, if the simulated spinning reels are shown to have stopped spinning showing three or more Ankh box reel symbols in result conveying component 301. At this point gaming graphic 300 is controlled to cause the reels 304 to darken to produce an expanded display area equivalent to the area of the result conveying component 301 and game character 306 is displayed traversing the darkened area and disappearing into the darkness. The graphic then may show the face of the game character 306 and fade into a cavern graphic as shown at FIG. 9A. This cavern graphic may expand to take up substantially the entire display area previously used for result conveying component 301 and background component 302 in FIG. 3. In the particular animation sequence indicated by FIGS. 9A-E, the game character is shown approaching a lever in the cavern wall as at FIG. 9A, and then pulling the lever as indicated at FIGS. 9B and 9C. The example animation sequence then shows a series of stepping stones floating into place over a chasm as at FIG. 9D. Ultimately the series of stepping stones suspended over the chasm are shown separating game character 306 from three treasure chests on the opposite side of the chasm as shown at FIG. 9E.

After the sequence of graphics shown in FIGS. 9A-E, the display device showing the graphic may be controlled (through CPU 205 and graphics card 215 in FIG. 2 for example) to play an interactive game in which game character 306 prompts the player to select stepping stones in an attempt to cross the chasm and reach the treasure chests. From the graphic display shown in FIG. 10A for example, the graphic may change to that shown in FIG. 10B in which a first series of stepping stones have changed color and game character 306 verbally prompts the player to select one of the highlighted stepping stones. After the player makes the selection, the graphic is controlled to show game character 306 jumping to the selected stepping stone as shown in FIG. 10C and the player may be awarded a bonus amount. The two other stones that were not selected may crumble way into the chasm as shown at FIG. 10D to reveal bonus amounts associated with those player selections. The sequence of selecting stepping stones continues as shown in FIGS. 10E-J until game character 306 traverses the chasm with a final leap shown at FIG. 10K, and reaches the treasure box as indicated at FIG. 10L. At any point, the graphic may be controlled such that the stepping stone to which game character 306 was directed may dissolve away so the character falls into the chasm to end the second screen bonus. Otherwise game character 306 eventually reaches the landing on which the three treasure chests are located and the player is prompted to select one of the treasure chests. Once the player has made their selection, game character 306 opens the selected treasure chest to show a result to be awarded to the player. This graphic may show game character 306 opening the selected treasure chest and removing an object which ultimately shows the result awarded to the player. Upon completion of the sequence of graphics indicated in FIGS. 10A-L (or from the point game character falls into the chasm as the case may be), the display is controlled to show the total value won for the play and then transitions to the original display as shown in any of FIGS. 3, 4, and 5.

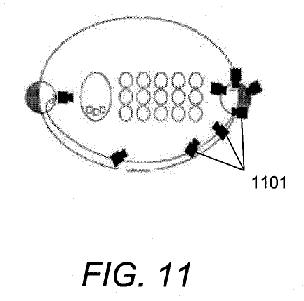

FIG. 11 shows various view positions 1101 from which the graphic shown in FIGS. 9A-E and 10A-L shows game character 306 in the course of this example second screen bonus game. Ultimately, the view position swings round from a position showing game character 306 walking down the tunnel and approaching the lever shown in FIG. 9A, to the final position in which the view shows the character jumping from one stepping stone to another to approach the view position.

In forms of the invention implemented through general purpose processing devices such as the devices shown in the example player station 100 of FIG. 2, the various steps described above and in the following claims are performed under the control of operational program code. One preferred form of the invention executes character interaction sequence program code at CPU 205 in FIG. 2 to cause the player station display device (e.g. display 104) to display the above-described example character interaction sequence.

The example displays shown in the figures are shown only as convenient examples for describing the principles of the invention. Many variations on these basic examples may be employed within the scope of the present invention. In particular, the invention is not limited to any particular manner for displaying the results for the game play. Also, numerous variations are possible in the playing rules of the game and the standards for presenting awards.

It should be noted again that the results for a given game play displayed in accordance with the above-described display techniques may be produced and communicated to the player station as necessary in any suitable manner within the scope of the invention. It should also be noted that the results indicated as bonuses in a character interaction sequence as described above, may be dictated by a single result obtained for a given play in the game. The result obtained for the given game play may represent a value and the graphic display is controlled by the presentation controller such as CPU 205 in FIG. 2 to show a total result consistent with that value dictated by the single result. The total result for a given game play may be divided between a partial result shown by the original graphic of the result conveying component, such as a result on a given reel payline, and a partial result shown as a result of a character interaction sequence according to the invention.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2005), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described preferred embodiments are intended to illustrate the principles of the invention, but not to limit the scope of the invention. Various other embodiments and modifications to these preferred embodiments may be made by those skilled in the art without departing from the scope of the present invention.

1. A method including:
(a) displaying a gaming graphic at a player station, the gaming graphic including a result conveying component and a background component with the background component located in a peripheral area surrounding at least a portion of the result conveying component;
(b) periodically changing the background component from a first configuration to a different configuration during the course of play at the player station; and
(c) maintaining the appearance of the result conveying component in a first configuration while the background component is periodically changed.

2. The method of claim 1 wherein the result conveying component includes a series of simulated spinnable reels.

3. The method of claim 1 further including storing two or more configurations for the background component and wherein changing the background component from the first configuration to the different configuration includes selecting one of the two or more stored configurations for the background component.

4. The method of claim 1 wherein the periodic change from the first background configuration to the different background configuration is performed based on the passage of time.

5. The method of claim 1 wherein the periodic change from the first background configuration to the different background configuration is performed based a number of plays made at the player station.

6. The method of claim 1 wherein the periodic change from the first background configuration to the different background configuration is performed randomly.

7. An apparatus including:
(a) a display device;
(b) a player input device;
(c) a presentation controller, the presentation controller for (i) causing the display device to display a gaming graphic, the gaming graphic including a result conveying component and a background component with the background component located in a peripheral area surrounding at least a portion of the result conveying component, for (ii) periodically changing the background component from a first configuration to a different configuration during the course of play at the player station and, for (iii) maintaining the appearance of the result conveying component while the background component is periodically changed.

8. The apparatus of claim 7 wherein the presentation controller includes a processing device of a player station that includes the display device and player input device.

9. The apparatus of claim 8 wherein the processing device of the player station generates a result for a game play at the player station.

10. The apparatus of claim 8 further including a result controller located remotely from the player station for communicating a result to the player station.

11. A method including:
(a) displaying a gaming graphic at a player station, the gaming graphic having a result conveying component and a background component, the background component including a game character;
(b) displaying the result conveying component in a character activating configuration; and
(c) displaying a character interaction sequence after displaying the result conveying component in the character activating configuration, the character interaction sequence including a visible interaction between the game character and one or more graphic symbols included in the result conveying component when in the character activating configuration.

12. The method of claim 11 wherein the visible interaction between the game character and one or more graphic symbols includes a representation of the game character shooting at least one of the one or more graphic symbols.

13. The method of claim 11 wherein the visible interaction between the game character and one or more graphic symbols includes a representation of the character traversing the result conveying component to interact with at least one of the one or more graphic symbols.

14. The method of claim 11 wherein the visible interaction between the game character and one or more graphic symbols includes a representation of the character removing at least one of the one or more graphic symbols from a position in the result conveying component.

15. The method of claim 11 further including producing verbal prompts coordinated with movement of the game character so that the verbal prompts appear to originate from the game character.

16. The method of claim 11 wherein the visible interaction between the game character and one or more graphic symbols includes a representation of the character traversing the result conveying component to a reel symbol area formed in the result conveying component, and a representation of the character passing through the reel symbol area.

17. The method of claim 16 further including expanding the reel symbol area to produce an expanded display area which replaces the result conveying component.

18. The method of claim 17 further including displaying an interactive bonus game presentation in the expanded display area.

19. An apparatus including:
(a) a display device;
(b) a player input device;
(c) a presentation controller, the presentation controller for (i) displaying a gaming graphic at a player station, the gaming graphic having a result conveying component and a background component, the background component including a game character, for (ii) displaying the result conveying component in a character activating configuration, and for (iii) displaying a character interaction sequence after displaying the result conveying component in the character activating configuration, the character interaction sequence including a visible interaction between the game character and one or more graphic symbols included in the result conveying component when in the character activating configuration.

20. The apparatus of claim 19 wherein the presentation controller includes a processing device of a player station that includes the display device and player input device.
